(19) United States
(12) Patent Application Publication
(10) Pub. No.: US 2024/0150515 A1
(43) Pub. Date: May 9, 2024

(54) Low Viscosity Catalyst Compositions for Producing Isocyanurate Polymers

(71) Applicant: Covestro Deutschland AG, Leverkusen (DE)

(72) Inventors: Andreas Hecking, Langenfeld (DE); Nicole Reidenbach, Leverkusen (DE); Estelle Lesker, Leverkusen (DE)

(21) Appl. No.: 18/278,482

(22) PCT Filed: Feb. 18, 2022
(86) PCT No.: PCT/EP2022/054027

§ 371 Date: Aug. 23, 2023

(30) Foreign Application Priority Data
Feb. 24, 2021 (EP) 21158884.3

(51) Int. Cl. C08G 18/18; C08G 18/73

(52) U.S. Cl. CPC C08G 18/1833; C08G 18/73

(57) ABSTRACT

The present invention relates to catalyst compositions including (i) urethane, thiourethane and urea adducts of amine catalysts and (ii) γ-diols with 3 to 12 carbon atoms as well their use for the crosslinking of aliphatically, cycloaliphatically, araliphatically or aromatically bonded isocyanate groups with one another.

### CROSS-REFERENCE TO RELATED APPLICATIONS

This application is the United States national phase of International Application No. PCT/EP2022/054027 filed Feb. 18, 2022, and claims priority to European Patent Application No. 21158884.3 filed Feb. 24, 2021, the disclosures of which are hereby incorporated by reference in their entireties.

### BACKGROUND OF THE INVENTION

### Field of the Invention

The present invention relates to catalyst compositions comprising (i) urethane, thiourethane and urea adducts of amine catalysts and (ii) γ-diols with 3 to 12 carbon atoms as well their use for the crosslinking of aliphatically, cycloaliphatically, araliphatically or aromatically bonded isocyanate groups with one another.

### Description of Related Art

The manufacture of polyisocyanurate plastics by crosslinking of aliphatic and/or cycloaliphatic polyisocyanates, i.e. without involvement of thiol, hydroxyl and amino groups is known as such, e.g. from EP 3 286 240. The use of such plastics in the matrix of composite materials has also been disclosed (e.g. in EP 3 452 529).

Most of the catalysts used for the trimerization of aromatic polyisocyanates (see e.g. J. H. Saunders, K. C. Frisch; Polyurethane Chemistry and Technology, 94 ff, 1962) are not suitable for the trimerization of the much less reactive aliphatic and cycloaliphatic polyisocyanates. A number of compounds have proven effective in the oligomerization of aliphatic diisocyanates (see e.g. H. J. Laas et al., J. Prakt. Chem. 1994, 336, 185 ff.). However, for the trimerization of oligomeric polyisocyanates these compounds either lack catalytic activity so that long reaction times at high temperatures are required, or they are too reactive so that the trimerization reaction cannot be controlled.

Catalysts with low activity at room temperature and high reactivity at elevated temperatures are especially required for the manufacture of composite materials with a polyisocyanurate matrix obtained from oligomeric aliphatic or cycloaliphatic polyisocyanates using the pultrusion process. This method is particularly suitable for the continuous and, thus, economic, manufacture of fibre-reinforced composite materials. Such thermolatent catalysts have been disclosed in WO 2019/197638. One disadvantage of these catalysts is their comparatively high viscosity of at least 250 Pa*s at room temperature (23° C.). Said viscosity poses a challenge for the uniform mixing of the oligomeric polyisocyanate and the catalyst which is the prerequisite for obtaining flawless matrix materials. Thus, there was a need for catalyst formulations with a similar activity profile as the known compounds but decreased viscosity at room temperature. Moreover, it was important that the catalyst formulation does not negatively impact the physical properties of the finished polyisocyanurate plastic. This problem has been solved by the embodiments defined below and in the claims.

EP 3 774 980 describes a reaction mixture comprising an HDI-based isocyanurate and an N,N,N′-triethylethanol amine as catalyst. Similarly, US 2021/047538 describes a reaction mixture comprising an HDI-based polyisocyanate, 2-[[2-(dimethylamino)ethyl]methylamino]ethanol as trimerization catalyst and methoxypropyl acetate as solvent. None of the two documents discloses presence of a γ-diol.

### SUMMARY OF THE INVENTION

In a first embodiment the present invention relates to a composition comprising
a) At least one adduct of a compound of formula (I) and a compound having at least one isocyanate group

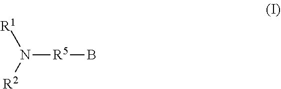

wherein R¹ and R² are independently of one another selected from the group consisting of hydrogen, methyl, ethyl, propyl, isopropyl, butyl and isobutyl, branched C5-alkyl, unbranched C5-alkyl, branched C6-alkyl, unbranched C6-alkyl, branched C7-alkyl and unbranched C7-alkyl;
R⁵ is selected from the group consisting of propylene, butylene, pentalene and a radical of formula (II), preferably from butylene and the radical of formula (II);

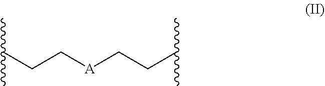

wherein A in formula (II) is selected from the group consisting of O, S and NR³, wherein R³ is selected from the group consisting of H, methyl, ethyl, propyl, isopropyl, butyl und isobutyl, preferably H and methyl; and
B is independently of A selected from the group consisting of OH, SH NHR⁴ and NH₂, wherein R⁴ is selected from the group consisting of methyl, ethyl and propyl, preferably methyl; and
b) at least one γ-diol with 3 to 12 carbon atoms.

When R⁵ is a radical of formula (II) a compound of formula (III) results

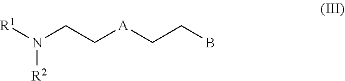

### Preferred Variants of the Compound of Formula (I)

In a preferred embodiment of the present invention R⁵ is a radical of formula (II), wherein A is NR³ and R³ is selected from the group consisting of hydrogen, methyl, ethyl, propyl, isopropyl, butyl and isobutyl. It is preferable when R³ is H, methyl or ethyl. It is particularly preferable when R³ is methyl.
In a first variant of this embodiment B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a second variant of this embodiment B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a third variant of this embodiment B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl. In this variant R⁴ is selected from the group consisting of methyl, ethyl and propyl. It is preferable when R⁴ is H, methyl or ethyl. It is particularly preferable when R⁴ is methyl.
In a fourth variant of this embodiment B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.

In a further preferred embodiment of this invention R⁵ is a radical according to formula (II), wherein A is oxygen.
In a first variant of this embodiment B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a second variant of this embodiment B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a third variant of this embodiment B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. It is particularly preferable when R¹ and R² are methyl. In this variant R⁴ is selected from the group consisting of methyl, ethyl and propyl. It is preferable when R⁴ is H, methyl or ethyl. It is particularly preferable when R⁴ is methyl.
In a fourth variant of this embodiment B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.

In yet a further preferred embodiment of this invention R⁵ is a radical according to formula (II), wherein A is sulfur.
In a first variant of this embodiment B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a second variant of this embodiment B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a third variant of this embodiment B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. It is particularly preferable when R¹ and R² are methyl. In this variant R⁴ is selected from the group consisting of methyl, ethyl and propyl. It is preferable when R⁴ is H, methyl or ethyl. It is particularly preferable when R⁴ is methyl.
In a fourth variant of this embodiment B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.

In yet a further preferred embodiment of this invention R⁵ is a butylene radical.
In a first variant of this embodiment B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a second variant of this embodiment B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.
In a third variant of this embodiment B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. It is particularly preferable when R¹ and R² are methyl. In this variant R⁴ is selected from the group consisting of methyl, ethyl and propyl. It is preferable when R⁴ is H, methyl or ethyl. It is particularly preferable when R⁴ is methyl.
In a fourth variant of this embodiment B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another H, methyl or ethyl. It is particularly preferable when R¹ and R² are methyl.

The superordinate term “adduct” is to be understood as meaning urethane, thiourethane and urea adducts of a compound of formula (I) with a compound having at least one isocyanate group. A urethane adduct is particularly preferred. The adducts according to the invention are formed when an isocyanate reacts with the functional group B of the compound defined in formula (I). When B is a hydroxyl group a urethane adduct is formed. When B is a thiol group a thiourethane adduct is formed. And when B is NH₂ or NHR⁴ a urea adduct is formed. To the extent that R¹ and/or R² are hydrogen this likewise forms urea adducts.

Contemplated isocyanates for producing the adducts according to the invention in principle include all isocyanates. The choice of suitable isocyanates is not limited to isocyanates having aliphatically, araliphatically and cycloaliphatically bonded isocyanate groups. Isocyanates having aromatically bonded isocyanate groups are likewise employable therefore. Monomeric and oligomeric polyisocyanates are also suitable. Since a suitable isocyanate must comprise at least one isocyanate group, monoisocyanates are likewise suitable for producing the adducts according to the invention. It is moreover possible to employ any isocyanate-functional prepolymer.

In a preferred embodiment of the present invention, the isocyanate used for producing the adduct is selected from the group consisting of MDI, TDI, XDI, TXDI, BDI, HDI, PDI, IPDI, oligomerized HDI, oligomerized PDI and oligomerized IPDI, mixtures of the abovementioned isocyanates and reaction products of the abovementioned isocyanates to the extent that these reaction products still contain at least one free isocyanate group.

If the intention is to produce thermolatent catalysts, it is preferable to employ an isocyanate having aliphatically or cycloaliphatically bonded isocyanate groups, more preferably a polyisocyanate having aliphatically bonded isocyanate groups and yet more preferably HDI. Said isocyanates may be in monomeric or oligomeric form. The use of oligomeric aliphatic polyisocyanates, in particular of oligomeric HDI, is very particularly preferred. The study underlying the present invention has shown that adducts of aliphatic isocyanates with compounds of formula (I) exhibit thermolatent behaviour in the crosslinking of both aliphatic and aromatic polyisocyanates.

In a preferred embodiment of the present invention the isocyanate composition used for producing the adduct according to the invention contains at least 20 mol %, preferably at least 50 mol %, more preferably at least 70 mol % yet more preferably at least 80 mol % and most preferably at least 90 mol % of isocyanate groups that are aliphatically or cycloaliphatically bonded. It is particularly preferable when the abovementioned proportions of isocyanate groups are aliphatically bonded. It is very particularly preferable when the isocyanate composition used for producing the adduct according to the invention contains at least 95 mol % of aliphatically bonded isocyanate groups, in particular as a constituent of HDI.

By contrast, if a catalyst achieving very high reaction rate is desired, it is preferable to employ adducts with aromatically bonded isocyanate groups. These isocyanates too may be in monomeric or oligomeric form.

It has been shown that adducts which are based on a mixture of isocyanates having aliphatically bonded isocyanate groups and isocyanates with aromatically bonded isocyanate groups have advantageous properties. Adducts which are based on a mixture of the aforementioned polyisocyanate species which comprises at least 50 wt.-% isocyanates with aliphatically bound isocyanate groups and 5 wt.-% to 50 wt.-% isocyanates with aromatically bound isocyanate groups have at most temperatures a viscosity which is lower than the viscosity of an adduct based purely polyisocyanates with aliphatically bound isocyanate groups. At the same time these adducts show an increased reaction rate while maintaining a sufficient pot life at lower temperatures. Thus, such adducts can be easily processed due to their low viscosity and do not need to be added to a reaction mixture in large quantities in order to enable a speedy reaction.

### DESCRIPTION OF THE INVENTION

Therefore, in a particularly preferred embodiment, the present invention relates to an adduct of a compound of formula (I) and at least one compound having at least one aliphatically bound isocyanate group and at least one further compound having at least one aromatically bound isocyanate group, wherein the first compound makes up at least 50 wt.-% of all isocyanates used for preparing the adduct and the second compound makes up 5 wt.-% to 50 wt.-% of all isocyanates used for preparing the adduct. More preferred is a range between a weight ratio of 5:95 and 35:65 (aromatic isocyanate: aliphatic isocyanate). Most preferred is a range between a weight ratio of 5:95 and 20:80 (aromatic isocyanate: aliphatic isocyanate).

It is preferred that the percentages given above to add up to at least 90 wt.-% of all isocyanates used for preparing the adduct, more preferably they add up to at least 98 wt.-%. Suitable isocyanates with aliphatically bound isocyanate groups are disclosed below in this application. Preferred are monomeric HDI, monomeric PDI, oligomeric HDI and oligomeric PDI. Suitable isocyanates with aromatically bound isocyanate groups are also disclosed below in this application. Preferred is MDI.

“Reaction products of the abovementioned isocyanates” are compounds formed by the reaction of one of the recited isocyanates with a further isocyanate, with an amine, thiol or alcohol or with a combination of an amine, thiol or alcohol and a further isocyanate. Concerned here are amines, thiols and alcohols which do not conform to formula (I). It is essential to the invention that the reaction product still comprises at least one free isocyanate group by means of which it may react with a compound of formula (I) and thus form an adduct according to the invention. Particularly preferred as reaction products are the isocyanate-bearing prepolymers more particularly defined hereinbelow.

### Production of the Adduct

In the production of the adduct according to the invention the stoichiometry of free isocyanate groups of the employed isocyanate or of the employed isocyanates and the compound of formula (I) is preferably chosen such that the molar ratio of the functional group B to the free isocyanate groups present is between 0.3:1.0 and 1.6:1.0, preferably between 0.9:1.0 and 1.4:1.0.

In a particularly preferred embodiment of the present invention the molar ratio of all isocyanate-reactive groups in the compound of formula (I) to the isocyanate groups of the compound having at least one isocyanate group is at least 1.0:1.0 and more preferably between 1.0:1.0 and 1.4:1.0. This embodiment is characterized in that the finished adduct/the finished catalyst composition no longer comprises any free isocyanate groups. If unreacted isocyanate groups are present in the finished catalyst composition the catalyst brings about during storage a slow crosslinking of these isocyanate groups with one another and thus a viscosity increase of the catalyst composition. If the amount of unreacted isocyanate groups in the finished catalyst composition is too high the viscosity increase can impair the usability of the catalyst composition and can even result in its complete curing so that a mixing of the catalyst composition with isocyanates to be crosslinked is impossible.

Production of the adducts according to the invention may be effected by any processes for producing urethanes, thiourethanes or ureas known to those skilled in the art. It is particularly advantageous when this is effected by slow mixing of the compound of formula (I) and of the employed isocyanate. The reaction generally proceeds by autocatalytic means. Should the reaction rate be insufficient without catalyst addition, the known urethane, thiourethane and urea-forming catalysts may be utilized.

In a preferred embodiment the isocyanate is slowly added to the catalyst optionally with cooling.

In a further preferred embodiment isocyanate and catalyst are quantitatively mixed in an optionally cooled static mixer or reactive mixer and reacted in an optionally cooled reaction tube.

In a further preferred embodiment isocyanate and catalyst are quantitatively mixed and reacted in a cooled static mixer.

It is preferable when the reaction of the catalyst with the isocyanate is carried out at temperatures of not more than 100° C., preferably not more than 80° C., particularly preferably not more than 60° C. and very particularly preferably not more than 40° C. and preferably under protective gas since this makes it possible to obtain products of optimal colour number. The temperature must be above the freezing point of the particular isocyanate and the reaction is preferably performed at a minimum temperature of 0° C.

### Polyisocyanate

In the present application the term “polyisocyanate” is to be understood as meaning any compound comprising on average at least 1.8, preferably at least 2.0 and particularly preferably 2.1 isocyanate groups. By contrast “monoisocyanate” is to be understood as meaning a compound having on average not more than 1.6 isocyanate groups per molecule, in particular only having one isocyanate group per molecule.

In the present application the term “polyisocyanates” refers to both monomeric and/or oligomeric polyisocyanates. For the understanding of many aspects of the invention, however, it is important to distinguish between monomeric diisocyanates and oligomeric polyisocyanates. Where reference is made in this application to “oligomeric polyisocyanates”, this means polyisocyanates formed from at least two monomeric diisocyanate molecules, i.e. compounds that constitute or contain a reaction product formed from at least two monomeric diisocyanate molecules.

### Oligomeric Isocyanates

Oligomeric isocyanates are obtained by “modification” of a monomeric isocyanate. “Modification” is to be understood as meaning the reaction of monomeric diisocyanates to afford oligomeric polyisocyanates having a uretdione, isocyanurate, allophanate, biuret, iminooxadiazinedione and/or oxadiazinetrione structure. Preferably employed as reactants for the production of oligomeric isocyanates are diisocyanates.

Thus for example hexamethylene diisocyanate (HDI) is a “monomeric diisocyanate” since it contains two isocyanate groups and is not a reaction product of at least two polyisocyanate molecules:

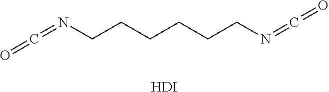 [SMILES: O=C=NCCCCCCN=C=O ; "HDI"]

By contrast, reaction products of at least two HDI molecules which still have at least two isocyanate groups are “oligomeric polyisocyanates” in the context of the invention. Proceeding from monomeric HDI representatives of such “oligomeric polyisocyanates” include for example the HDI isocyanurate and the HDI biuret each constructed from three monomeric HDI units:

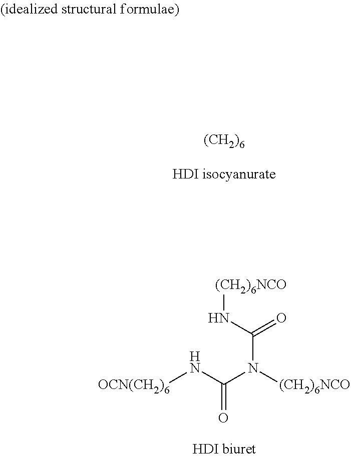

Production processes for oligomeric polyisocyanates having a uretdione, isocyanurate, allophanate, biuret, iminooxadiazinedione and/or oxadiazinetrione structure are described, for example, in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

It is particularly preferable when the monomeric isocyanates defined hereinbelow are used as the starting materials for modification.

### Isocyanates Having Aliphatically Bonded Isocyanate Groups

In an isocyanate having aliphatically bonded isocyanate groups all isocyanate groups are bonded to a carbon atom that is part of an open carbon chain. This may be unsaturated at one or more sites. The aliphatically bonded isocyanate group or—in the case of polyisocyanates—the aliphatically bonded isocyanate groups are preferably bonded at the terminal carbon atoms of the carbon chain.

Polyisocyanates having aliphatically bonded isocyanate groups that are particularly suitable according to the invention are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane and 1,10-diisocyanatodecane.

### Isocyanates Having Cycloaliphatically Bonded Isocyanate Groups

In an isocyanate having cycloaliphatically bonded isocyanate groups all isocyanate groups are bonded to carbon atoms which are part of a closed ring of carbon atoms. This ring may be unsaturated at one or more sites provided that it does not attain aromatic character as a result of the presence of double bonds. Polyisocyanates having cycloaliphatically bonded isocyanate groups that are particularly suitable according to the invention are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

### Isocyanates Having Araliphatically Bonded Isocyanate Groups

In an isocyanate having araliphatically bonded isocyanate groups all isocyanate groups are bonded to methylene radicals which are in turn bonded to an aromatic ring.

Polyisocyanate having aliphatically bonded isocyanate groups that are particularly suitable according to the invention are 1,3- and 1,4-bis(isocyanatomethyl)benzene (xyxlylene diisocyanate; XDI), 1,3- and 1,4-bis(1-isocyanato-1-methylethyl)benzene (TMXDI) and bis(4-(1-isocyanato-1-methylethyl)phenyl) carbonate.

According to the invention the polymerizable composition may contain any desired mixtures of the abovementioned isocyanates in monomeric and/or oligomeric form.

### Isocyanate Having an Aromatically Bonded Isocyanate Group

In an isocyanate having aromatically bonded isocyanate groups all isocyanate groups are bonded directly to carbon atoms which are part of an aromatic ring.

Isocyanates having aromatically bonded isocyanate groups that are particularly suitable according to the invention are 2,4- and 2,6-diisocyanatotoluene (TDI), 2,4′- and 4,4′-diisocyanatodiphenylmethane (MDI) and 1,5-diisocyanatonaphthalene.

### Monoisocyanates

Monoisocyanates particularly suitable according to the invention are preferably selected from the group consisting of n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- or 4-methylcyclohexyl isocyanate, methylbenzyl isocyanate, methyl isocyanate, (trimethylsilyl) isocyanate, 1-naphtyl isocyanate, 3-methyl-2-butyl isocyanate, 1-(4-methoxyphenyl)ethyl isocyanate, 1-(3-methoxyphenyl)ethyl isocyanate, 1-phenylpropyl isocyanate, 2-octyl isocyanate, 2-heptyl isocyanate, 4-butyl-2-methylphenyl isocyanate, 3-(triethoxysilyl)propyl isocyanate, 2-benzyloxycyclohexyl isocyanate, 1-(4-chlorophenyl)ethyl isocyanate, 2-nonyl isocyanate, 1-(4-bromophenyl)ethyl isocyanate, 2,1,3-benzothiadiazol-4-yl isocyanate, p-phenylazophenyl isocyanate, phenyl isocyanate, ethyl isocyanate, chlorosulfonyl isocyanate, allyl isocyanate, benzyl isocyanate, propyl isocyanate, isoproyl isocyanate, furfuryl isocyanate, propyl isocyanate, octadecyl isocyanate, trichloroacetyl isocyanate, benzoyl isocyanate, phenethyl isocyanate, p-tolyl isocyanate, o-tolyl isocyanate, m-tolylisocyanat, 3,4-dimethoxyphenyl isocyanate, 2,4-dimethoxyphenyl isocyanate, 3,5-dimethoxyphenyl isocyanate, 2,5-dimethoxyphenyl isocyanate, tert-butyl isocyanate, 3,5-dimethylphenyl isocyanate, 2,6-dimethylphenyl isocyanate, 4-ethylphenyl isocyanate, 4-methylbenzyl isocyanate, 2-methylbenzyl isocyanate, 3-methylbenzyl isocyanate, 4-methoxyphenyl isocyanate, 4-tert-butylphenyl isocyanate, 2-methoxyphenyl isocyanate, 3,4,5-trimethoxyphenyl isocyanate, 2,4-dimethoxybenzyl isocyanate, 4-phenylbutyl isocyanate, 4-ethylphenethyl isocyanate, 4-methoxybenzyl isocyanate, benzenesulfonyl isocyanate, 2-methoxybenzyl isocyanate, 3-ethoxyphenyl isocyanate, 3-methoxybenzyl isocyanate, 2,2-diphenylethyl isocyanate, 1,1,3,3-tetramethylbutyl isocyanate, 2-ethylhexyl isocyanate, 4-biphenylyl isocyanate, 3-phenylpropyl isocyanate, 2,3-dimethoxyphenethyl isocyanate, decyl isocyanate, cyclohexanemethyl isocyanate, 3,4-methylendioxyphenethyl isocyanate, 3,4-dimethoxyphenethyl isocyanate, 5-indanyl isocyanate, cycloheptyl isocyanate, 2-phenylcyclopropyl isocyanate, 1-cyclohexylethyl isocyanate, 4-nitrophenyl isocyanate, 1-adamantyl isocyanate, 2-nitrophenyl isocyanate, 3-nitrophenyl isocyanate, pyridine-3-isocyanate, chloroacetyl isocyanate, 2,6-diisopropylphenyl isocyanate, hexadecyl isocyanate, 4-acetylphenyl isocyanate, 4-phenoxyphenyl isocyanate, 4-pentylphenyl isocyanate, 3-phenoxyphenyl isocyanate, p-toluenesulfonyl isocyanate, 2-chloroethyl isocyanate, 2-bromophenyl isocyanate, 3-chlorophenyl isocyanate, 2-chlorophenyl isocyanate, 4-bromophenyl isocyanate, 4-chlorophenyl isocyanate, 2-naphthyl isocyanate, 4-fluorophenyl isocyanate, 2-bromoethyl isocyanate, 4-cyanophenyl isocyanate, 3,4-dichlorophenyl isocyanate, 2,3,4-trifluorophenyl isocyanate, 3-cyanophenyl isocyanate, 2,6-dichlorophenyl isocyanate, diethoxyphosphinyl isocyanate, 2,4-dichlorophenyl isocyanate, 3,3,4,4,5,5,6,6,7,7,8,8,9,9,10,10,10-heptadecafluorodecyl isocyanate, 4-fluorobenzyl isocyanate, 2-fluorophenyl isocyanate, 3-chloropropyl isocyanate, 3-fluorophenyl isocyanate, 4-iodophenyl isocyanate, 3,5-dichlorophenyl isocyanate, 4-chlorobenzenesulfonyl isocyanate, 2,4,6-tribromophenyl isocyanate, 2-iodophenyl isocyanate, 3,4-difluorophenyl isocyanate, 3-bromophenyl isocyanate, 2,4-dichlorobenzyl isocyanate, 2,5-difluorophenyl isocyanate, 2-benzylphenyl isocyanate, 2-fluorobenzyl isocyanate, 4-fluorophenethyl isocyanate, pentafluorophenyl isocyanate, 2,4-dichlorophenethyl isocyanate, 4-chlorobenzyl isocyanate, diphenylmethyl isocyanate, tributyltin isocyanate, 2-chlorobenzenesulfonyl isocyanate, 2-chlorobenzyl isocyanate, 3,3-diphenylpropyl isocyanate, 3,4,5-trimethoxybenzyl isocyanate, 3-chlorophenethyl isocyanate, 3-fluorobenzyl isocyanate, 2,6-difluorophenyl isocyanate, 3-iodophenyl isocyanate, 2,4-difluorophenyl isocyanate, 2-cyanophenyl isocyanate, 2-fluorophenethyl isocyanate, 2-thienyl isocyanate, 3,4-dichlorobenzyl isocyanate, 3,4-dichlorophenethyl isocyanate, 4-benzylphenyl isocyanate, 4-bromobenzyl isocyanate, 4-fluorobenzosulfonyl isocyanate, mPEG5K isocyanate, 3,5-dimethylisoxazol-4-yl isocyanate, 2-methoxy-5-methylphenyl isocyanate, 2-(4-biphenyl)ethyl isocyanate, 2-ethyl-6-methylphenyl isocyanate, 2-methyl-5-phenyl-3-furyl isocyanate, 1-(1-naphthyl)ethyl isocyanate, 3,4-(methylenedioxy)phenyl isocyanate, 2,3-dihydro-1-benzofuran-5-yl isocyanate, 4-methoxy-2-nitrophenyl isocyanate, 3,5-bis(trifluoromethyl)phenyl isocyanate, 4-(maleimido)phenyl isocyanate, 4-(dimethylamino)phenyl isocyanate, 3-(trifluoromethyl)phenyl isocyanate, 4-(chlorosulfonyl)phenyl isocyanate, 3-isopropenyl-α,α-dimethylbenzyl isocyanate, 3-chloro-4-methylphenyl isocyanate, 4-(trifluoromethyl)phenyl isocyanate, 2-(trifluoromethyl)phenyl isocyanate, 4,4′-oxybis(phenylisocyanate), 4-(chloromethyl)phenyl isocyanate, 4-chloro-3-(trifluoromethyl)phenyl isocyanate, 9H-fluoren-2-yl isocyanate, 2-(chloromethyl)phenyl isocyanate, 2-fluoro-5-(trifluoromethyl)phenyl isocyanate, 2-fluoro-3-(trifluoromethyl)phenyl isocyanate, 4-(benzyloxy)phenyl isocyanate, 4-fluoro-3-(trifluoromethyl)phenyl isocyanate, 4-fluoro-3-methylphenyl isocyanate, 3-fluoro-5-(trifluoromethyl)phenyl isocyanate, 4-chloro-2-fluorophenyl isocyanate, 5-fluoro-2-methylphenyl isocyanate, 2,3-dimethyl-6-nitrophenyl isocyanate, 2-(trifluoromethoxy)phenyl isocyanate, 2-fluoro-5-methylphenyl isocyanate, 4-(difluoromethoxy)phenyl isocyanate, 4-methyl-2-nitrophenyl isocyanate, 3-fluoro-2-methylphenyl isocyanate, 4-(trifluoromethylthio)phenyl isocyanate, 4-fluoro-2-(trifluoromethyl)phenyl isocyanate, 1-(4-fluorophenyl)ethyl isocyanate, 1-benzothiophen-5-yl isocyanate, 2-(difluoromethoxy)phenyl isocyanate, 2-(thien-2-yl)ethyl isocyanate, 2-bromo-4,6-difluorophenyl isocyanate, 2-chloro-4,6-dimethylphenyl isocyanate, 2-chloro-4-(trifluoromethyl)phenyl isocyanate, 2-chloro-4-(trifluoromethylthio)phenyl isocyanate, 2-chloro-5-methylphenyl isocyanate, 2-fluoro-4-iodophenyl isocyanate, 3-bromo-2,4,6-trimethylphenyl isocyanate, 3-chloro-2-fluorphenyl isocyanate, 3-chloro-2-methylphenyl isocyanate, 4-(trifluoromethyl)benzyl isocyanate, 4-bromo-2,6-difluorophenyl isocyanate, 4-bromo-2,6-dimethylphenyl isocyanate, 4-bromo-2-(trifluoromethyl)phenyl isocyanate, 4-bromo-2-chloro-6-methylphenyl isocyanate, 4-bromo-2-chloro-6-methylphenyl isocyanate, 4-bromo-2-ethylphenyl isocyanate, 4-chloro-2-phenoxyphenyl isocyanate, 4-ethoxy-2-nitrophenyl isocyanate, 4-fluoro-2-nitrophenyl isocyanate, 5-chloro-2-methylphenyl isocyanate, 5-chloro-2-phenoxyphenyl isocyanate, 5-methyl-2-nitrophenyl isocyanate, 5-phenyl-2-thienyl isocyanate, 6-fluoro-4H-1,3-benzodioxin-8-yl isocyanate, 9H-fluoren-9-yl isocyanate, benzyl isocyanate, ethyl isocyanate, trichloroacetyl isocyanate, 1-phenylethyl isocyanate, ethyl isocyanate formate, isocyanatophosphonic dichloride, 2-isocyanatoethyl methacrylate, 3-isocyanato-4-methoxybiphenyl, 2,4,6-trichlorophenyl isocyanate, triphenylsilyl isocyanate, 2,6-dibromo-4-ethylphenyl isocyanate, 2-chloro-4-nitrophenyl isocyanate, 2-tert-butyl-6-methylphenyl isocyanate, 4,4′-methylenebis(2-chlorophenyl isocyanate), 4,5-dimethyl-2-nitrophenyl isocyanate, 4-chloro-2-(trifluoromethyl)phenyl isocyanate, 4-chloro-2-nitrophenyl isocyanate, 1-isocyanato-2,3-dimethoxybenzene, 3-isocyanatopentane, isocyanatocyclobutane, isocyanato(methoxy)methane, ethyl (4-isocyanatophenyl)acetate, ethyl 4-(isocyanatomethyl)cyclohexanecarboxylate, 1,1-dimethoxy-2-isocyanatoethane, 1-chloro-3-fluoro-2-isocyanatobenzene, 2-chloro-3-fluorophenyl isocyanate, 2-isocyanato-3-methylbutyric acid methyl ester, 2-isocyanato-5-methylbenzonitrile, 5-chloro-2-isocyanatobenzonitrile, 5-ethyl-2-isocyanatobenzonitrile, 6-isocyanatohexanoic acid methyl ester, dimethyl 2-isocyanatoterephthalate, ethyl 2-isocyanato-4-methylvalerate, methyl 2-isocyanato-4-(methylsulfanyl)butanoate, methyl 2-isocyanato-4-methylpentanoate, ethyl isocyanatoacetate, phenyl isocyanatoformate, methyl 4-isocyanatobenzoate, methyl 3-isocyanatobenzoate, methyl isocyanatoformate, dimethyl 5-isocyanatoisophthalate and any desired mixtures of such monoisocyanates.

Thioisocyanates are likewise suitable. Preferred thioisocyanates are selected from the group consisting of 4-fluorobenzyl isothiocyanate, dibutyltin diisothiocyanate, 2,6-difluorophenyl isothiocyanate, 3-cyanophenyl isothiocyanate, 3-nitrophenyl isothiocyanate and phenyl isocyanate.

Particular preference is given to monoisocyanates selected from the group consisting of cyclohexyl isocyanate, phenyl isocyanate, octadecyl isocyanate and hexyl isocyanate.

Likewise suitable are mono- or polyisocyanates obtained by the modification of monomeric isocyanates as described hereinabove.

Prepolymers

Isocyanate-bearing prepolymers suitable for the production of the adducts according to the invention are obtained by reaction of an alcohol, an amine or a thiol with a polyisocyanate. A molar excess of isocyanate groups to isocyanate-reactive groups must be present.

Suitable alcohols are mono- or polyhydric monomeric alcohols, preferably selected from the group consisting of hexanol, butanediol.

The polyether diols and polycarbonate diols known from the prior art are also suitable for producing the adduct according to the invention.

Preferred as the isocyanate for the production of the isocyanate-bearing prepolymer are HDI in monomeric form, oligomerized HDI and mixtures thereof.

### γ-Diol Having 3 to 12 Carbon Atoms

The term “γ-diol having 3 to 12 carbon atoms” refers to any compound having two hydroxyl groups bound to carbon atoms which are connected by a further carbon atom, preferably a methylene group. In principle, any diol meeting these requirements is suitable for use in the composition of the present invention. This includes branched and non-branched aliphatic diols, cycloaliphatic diols and aromatic diols provided that the two carbon atoms carrying hydroxyl groups are separated by a further carbon atom.

More preferably, the γ-diol is a 1,3-diol. Preferred 1,3-diols are 1,3-propanediol, 1,3-butanediol, 2-ethylhexane-1,3-diol.

It is particularly preferred that the 1,3-diol is a branched or non-branched aliphatic diol. Preferred branched and non-branched aliphatic diols are 1,3-propanediol, 1,3-butanediol and 2-ethylhexane-1,3-diol.

Composition

The composition of the present invention is a catalyst composition suitable for storage and transport. Therefore, it is preferred that the composition only contains a limited concentration of free mono- and polyisocyanates. The term “free mono- and polyisocyanates” refers to all compounds having at least one free isocyanate group and which are not part of the adduct defined above. As the adduct catalyzes the crosslinking of isocyanate groups to form isocyanurate groups the presence of free mono- and polyisocyanates would cause a slow polymerization reaction during storage or transport, especially if the temperature is inadvertently increased.

Therefore, it is preferred that the composition of the invention does not contain more than 2 wt.-%, preferably not more than 1 wt.-% of free mono- and polyisocyanates, wherein the aforementioned weight percentages are based on the total mass of the composition.

It is also preferred that the composition of the present invention consists to at least 90 wt.-%, more preferably at least 95 wt.-% and most preferably at least 98 wt.-% of the at least one adduct of a compound of formula (I) (component a) and the at least one at least one γ-diol with 3 to 12 carbon atoms (component b).

Preferably, the weight ratio between component b (the γ-diol) and component a (the adduct) is 1:1 to 1:100, more preferably 1:4 to 1:16 and most preferably 1:6 to 1:12.

In a preferred embodiment of the present invention, the weight ratio is chosen such that the viscosity of the composition is not more than 100 Pa*s at 23° C. according to DIN EN ISO 3219. Preferably, the viscosity is determined according to DIN EN ISO 3219 with a rotation viscosimeter.

The composition has the capability to catalyse the crosslinking of isocyanate groups to form isocyanurate groups. Thus, it is a catalyst composition.

In a second embodiment, the present invention relates to the use of the above-defined composition for the formation of isocyanurate groups. Thus, this embodiment relates to the use of the composition as catalyst composition.

The structure of the isocyanurate group is disclosed above in this application. It is formed by addition of three isocyanate groups. Thus, the use according to the present invention entails the mixing of the composition of the present invention with an isocyanate composition at a temperature, where the composition does not show relevant activity. Such a temperature is any temperature below 50° C., preferably below 40° C. The formation of the isocyanurate group is then effected by exposing the mixture to an increased temperature of at least 60° C., preferably at least 80° C. The temperature must not exceed 300° C. The mixture comprising the isocyanate composition and the catalyst composition will be referred to as “reaction mixture” or “polymerizable composition”.

The catalyst content of the polymerizable composition is preferably 0.1 to 8.0 wt.-%, more preferably 0.3 to 5.0 wt.-% and even more preferably 0.5 to 3.0 wt.-%.

The polymerizable composition my comprise compounds having isocyanate-reactive groups to some extent. As component b itself has hydroxyl groups, this is in fact inevitable. However, in order to limit undesired side reactions, the molar ratio of isocyanate groups to isocyanate-reactive groups in the polymerizable composition is preferably at least 3:1, more preferably at least 5:1 and most preferably at least 10:1. The term “isocyanate-reactive groups” is to be understood as meaning hydroxyl, thiol and amino groups.

The term “isocyanate composition” refers to the totality of all compounds carrying at least one isocyanate group added to the reaction mixture with the exception of component a. Preferably, the isocyanate composition comprises monomeric and/or oligomeric polyisocyanates as defined above in this application. For reasons of industrial safety, preference is in principle given to polymerizable compositions comprising an isocyanate composition which consists to an extent of at least 90 wt.-%, preferably at least 95 wt.-% and more preferably at least 98 wt.-% of oligomeric polyisocyanates.

In a preferred embodiment of the present invention, the isocyanate component consists to at least 50 wt.-%, more preferably to at least 75 wt.-%, even more preferably to at least 90 wt.-% and most preferably to at least 95 wt.-% of aliphatic and/or cycloaliphatic polyisocyanates.

In another preferred embodiment of the present invention, the composition of the present invention is used to form a polyisocyanurate plastic which forms the matrix of a composite material. For this embodiment it is preferred that the polymerizable composition comprises a fibrous filler as additional component.

Suitable fibrous fillers are, for example, all inorganic fibres, organic fibres, natural fibres or mixtures thereof that are known to those skilled in the art.

According to the invention, suitable fibrous fillers are all fibres having an aspect ratio greater than 1000, preferably greater than 5000, more preferably greater than 10 000 and most preferably greater than 50 000. The aspect ratio is defined as the length of the fibres divided by the diameter.

While complying with the above-defined aspect ratio, the fibrous fillers preferably have a minimum length of 1 m, more preferably 50 m and most preferably 100 m.

Preferred inorganic fibres are glass fibres, basalt fibres, boron fibres, ceramic fibres, whiskers, silica fibres and metallic reinforcing fibres. Preferred organic fibres are aramid fibres, polyethylene fibres, carbon fibres, carbon nanotubes, polyester fibres, nylon fibres and Plexiglas fibres. Preferred natural fibres are flax fibres, hemp fibres, wood fibres, cellulose fibres and sisal fibres.

In a preferred embodiment of the invention, the fibrous filler is selected from the group consisting of glass fibres, basalt fibres, carbon fibres and mixtures thereof. The fibres may be in individual form, but they can also be woven or knitted in any form known to those skilled in the art to give mats or fleeces. Preferably less than 50% by weight, more preferably less than 35% by weight, even more preferably less than 20% by weight and most preferably less than 10% by weight of the fibres used are in the form of mats or fleeces.

The individual fibres preferably have a diameter of less than 0.1 mm, more preferably less than 0.05 mm, and even more preferably less than 0.03 mm.

In a preferred embodiment of the invention, there is a sizing on the surface of the fibres. The sizing is a thin polymer film which frequently contains reactive groups and which improves wetting with the resin or the binding between the matrix and the fibre.

A polyisocyanurate plastic is a solid material which is formed by mixing the composition of the present invention with a polyisocyanate composition having an average functionality of at least 1.8, preferably at least 2.0 and most preferably at least 2.2 isocyanate groups per molecule. Trimerization of the isocyanate groups of such an isocyanate composition leads due to the high functionality of the isocyanate composition inevitably to a solid material.

Surprisingly, the study underlying the present invention has shown that not any type of alcohol is a suitable diluent for a compound according to formula (I). Gel times of 24 hours and more were only achieved with γ-diols. Monohydric alcohols such as ethanol or isopropanol as well as 1,4-butane diol or 1,2-propane diol led to much lower gel times. At the same time, the finished material had a high glass transition temperature, generally above 100° C.

### Method

In a third embodiment the present invention relates to a method for manufacturing a polyisocyanurate plastic, comprising the steps of
a) Providing the composition of the present invention;
b) Mixing the composition of the present invention with a polyisocyanate composition so that a reaction mixture is formed; and
c) curing the reaction mixture obtained in method step b) at a temperature between 60° C. and 300° C.

All definitions with respect to the composition of the present invention, polyisocyanates and the polymerizable composition given above also apply to this embodiment.

The “provision” of the composition of the present invention in method step a) relates to any act or sequence of acts which results in a homogenous mixture of components a) and b). The person skilled in the art is well aware of suitable mixing methods. In a typical case, the composition will be bought pre-mixed so that it can be used simply by adding it to the polyisocyanate composition. In this case, the mixing step will not be performed by the user of the composition. In this typical case, the term “providing” simply refers to the act of obtaining the composition of the present invention from a third party, particularly a commercial supplier.

Similarly, the mixing of the composition of the present invention and the polyisocyanate composition in method step b) can be achieved by any methods known to the person skilled in the art. Given the reactivity of the reaction mixture, it is preferred to perform method step b) at a temperature of 50° C. or less, more preferably 40° C. or less.

As the aim of the method is the production of a polyisocyanurate plastic, it is essential that a polyisocyanate composition is used in method step b). Such a composition comprises all compounds carrying isocyanate groups with the exception of component a) present in the reaction mixture. The average isocyanate functionality of the polyisocyanate composition is at least 1.8, preferably at least 2.0 and most preferably at least 2.2 isocyanate groups per molecule.

It is preferred that the polyisocyanate composition consists to at least 50 wt.-%, more preferably to at least 75 wt.-%, even more preferably to at least 90 wt.-% and most preferably to at least 95 wt.-% of aliphatic and/or cycloaliphatic polyisocyanates.

The curing in method step c) is effected by raising the temperature of the reaction mixture to the above-defined temperatures. In a preferred embodiment of the present invention, the curing is performed at a temperature between 80° C. and 300° C., more preferably at a temperature between 100° C. and 300° C. As polyisocyanates as well as polyisocyanurate plastics decompose at higher temperatures, in method step c) the upper temperature limit should not be exceeded.

Method step c) is performed until the curing of the reaction mixture is essentially complete. This is preferably the case when the reaction mixture is dry to touch. In order to achieve this, method step c) is preferably continued until not more than 20%, more preferably not more than 10% and most preferably not more than 5% of the isocyanate groups originally present in reaction at the beginning of method step c) remain.

A reaction mixture comprising the catalyst composition of the present invention is characterized by a long pot life at room temperature. Thus, after the mixing in method step b) the reaction mixture may be stored for an extended time without suffering from a steep increase of its viscosity. It is preferred that the reaction mixture reaches its gel point only after at least 12 hours, preferably at least 24 hours, when stored at a temperature of not more than 50° C., preferably not more than 40° C. Therefore, in a preferred embodiment of the present invention, method step c) is initiated 1 to 24 hours, preferably 1 to 12 hours after the end of method step b).

In another preferred embodiment of the present invention, a fibrous filler as defined further above in this application is added to the reaction mixture prepared in method step b) before method step c) is initiated.

Polyisocyanurate Plastic

In a fourth embodiment, the present invention relates to a polyisocyanurate plastic obtained or obtainable by the method defined above.

Preferably, a “polyisocyanurate plastic” is characterized by a proportion of carbon bound within isocyanurate groups, based on the total carbon content of the polyisocyanurate plastic of at least 8%, more preferably at least 12% and most preferably at least 16%. Carbon which may be present in any filler, in particular a fibrous filler, is not taken into account, as the filler does not form part of the isocyanurate plastic.

The carbon content bound within isocyanurate groups can be calculated, for example, from the integrals of proton-decoupled ¹³C NMR spectra (MAS NMR, solid-state NMR), since the carbon atoms give characteristic signals in accordance with their bonding, and relate to the sum total of all carbon signals present.

The following examples are merely intended to illustrate the present invention. They shall not limit the scope of the claims in any way.

### Working Examples

### General Information

All percentages given are wt.-% unless explicitly indicated otherwise.

The temperature at the time of performing the experiments was 23° C. This temperature will be referred to as room temperature.

The methods set forth below for determining the respective parameters were used in the experiments and are the preferred methods for determining the relevant parameters given above in this application.

### Determination of Dynamic Viscosity

Dynamic viscosity was determined at 23° C. with a viscometer VT 550 from company Haake. By using different shearing rates it was ensured that the rheology of the catalyst solutions and the control solutions corresponded to the rheology of ideal Newtonian fluids. Thus, the shear rate does not need to be indicated.

### Determination of Gel Time

Gelt time was determined at standard climate with a Gelnorm Geltimer GT-SP (Gel Instrumente AG, Switzerland) in analogy to DIN 16 945. The device performs a stroke lasting 10 seconds and stops when the gel point is reached. An integrated timer shows the timer until gelation.

### Determination of Phase Transitions by DSC

The phase transitions were determined by means of DSC (differential scanning calorimetry) with a Mettler DSC 12E (Mettler Toledo GmbH, Giessen, Germany) in accordance with DIN EN 61006. Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 320 K/min. Cooling was effected by means of liquid nitrogen. The purge gas used was nitrogen. The values reported are in each case based on evaluation of the 2nd heating curve. The melting temperatures Tₘ were obtained from the temperatures at the maxima of the heat flow curve. The glass transition temperature T_{g} was obtained from the temperature at half the height of a glass transition step.

### Determination of Infrared Spectra

The infrared spectra were measured on a Bruker FT-IR spectrometer equipped with an ATR unit.

### Starting Compounds

The polyisocyanate is an HDI trimer (functionality >3) with a NCO content of 23.0 wt.-% obtained from Covestro AG. The viscosity was 1200 mPa-s at 23° C. (DIN EN ISO 3219/A.3). The polyisocyanate was degassed under vacuum.

2-(2-dimethylaminoethoxy)ethanol with an OH-number of 421 mg KOH/g was obtained from Huntsman Corporation.

Solvent 1: water, deionized

Solvent 2: ethanol

Solvent 3: 2-propanol

Solvent 4: 1,2-propanediol

Solvent 5: 1,3-propanediol

Solvent 6: 1,3-butanediol

Solvent 7: 1,4-butanediol

Solvent 8: 2-ethyl-1,3-hexanediol

Solvent 9: glycerol

Additive: Desmorapid® AP 300, zinc stearate with fatty acid ester (Additive 7000, Munch Chemie) obtained from Covestro AG.

### Manufacture of the Catalyst Adduct

6.28 g polyisocyanate were added dropwise to 5.00 g of 2-(2-dimethylaminoethoxy)ethanol with cooling and stirred until a homogenous mixture was obtained. The complete reaction was confirmed by IR-spectroscopy for the detection of free NCO-groups (NCO band at 2270 m⁻¹).

TABLE 1
Composition of the catalyst solution (catalyst and alcohol/water)

| | | | Solvent | Viscosity |
|---|---|---|---|---|
| Example | | Solvent | [wt.-%] | [mPa*s at 23° C.] |
| 1 | comparative | none | 0 | 287,000 |
| 2 | comparative | water | 10 | 35,500 |
| 3 | comparative | Ethanol | 10 | 10,100 |
| 4 | comparative | 2-Popanol | 10 | 13,700 |
| 5 | comparative | 1,3-Propanediol | 50 | 800 |
| 6 | comparative | 1,3-Propanediol | 33 | 4550 |
| 7 | comparative | 1,3-Propanediol | 20 | 15,300 |
| 8 | comparative | 1,3-Propanediol | 14 | 32,500 |
| 9 | inventive | 1,3-Propanediol | 10 | 61,000 |
| 10 | inventive | 1,3-Butanediol | 10 | 71,800 |
| 11 | comparative | 1,4-Butanediol | 10 | 74,700 |
| 12 | inventive | 2-Ethyl-1,3-hexanediol | 10 | 106,000 |
| 13 | comparative | Glycerol | 10 | 220,000 |

### Reaction Mixture

The reaction mixture was produced by adding polyisocyanate to the appropriate amount of catalyst solution and additives at_23° C. in a speed mixer DAC 150.1 FVZ (Hauschild, Germany). The amount of catalyst solution was chosen so that the actual amount of catalyst adduct in the reaction mixture could be kept constant. The amount of polyisocyanate was then chosen so that the total mass of the reaction mixture including the additive was 100 g (see table 2). The gel time of the reaction mixture was then determined (see table 3). This parameter indicates the onset of the crosslinking reaction. Gelation of the reaction mixture within the first 24 hours of the experiment was considered a failure as such short gel times do not leave enough time to use the mixture.

In an additional experiment 5 g of the reaction mixture were without further treatment cast in a mold and cured in an oven for 5 minutes at 180° C.

TABLE 2

| | | Polyisoscyanate | Catalyst solution | Catalyst solution | Additive |
|---|---|---|---|---|---|
| Example | | [g] | # | [g] | [g] |
| 14 | comparative | 94.8 | 1 | 1.20 | 4.0 |
| 15 | comparative | 94.7 | 2 | 1.3 | 4.0 |
| 16 | comparative | 94.7 | 3 | 1.3 | 4.0 |
| 17 | comparative | 94.7 | 4 | 1.3 | 4.0 |
| 18 | comparative | 93.6 | 5 | 2.4 | 4.0 |
| 19 | comparative | 94.2 | 6 | 1.8 | 4.0 |
| 20 | comparative | 94.5 | 7 | 1.5 | 4.0 |
| 21 | comparative | 94.6 | 8 | 1.4 | 4.0 |
| 22 | inventive | 94.7 | 9 | 1.3 | 4.0 |
| 23 | inventive | 94.7 | 10 | 1.3 | 4.0 |
| 24 | comparative | 94.7 | 11 | 1.3 | 4.0 |
| 25 | inventive | 94.7 | 12 | 1.3 | 4.0 |
| 26 | comparative | 94.7 | 13 | 1.3 | 4.0 |

### Application Testing

Finally, the cured products were examined. The optical assessment primarily describes foaming of the product. Visible red-brownish colouring as well as strong foaming are undesirable because they make further processing difficult. The physical and chemical analysis of the products encompass an IR-spectrum and determination of the Tg. A complete IR-spectrum was measured in order to check for complete consumption of the free NCO-group. The ratio between CH stretching at 2800 to 3000 m⁻¹ and the NCO-band at 2270 m⁻¹ was calculated. In all samples the height of the NCO-bands was only approximately 50% of that of CH stretching indicating complete consumption of NCO-groups.

Furthermore, the Tg of the products was determined by DSC (see table 3). The Tg can be used as a direct measure of the crosslinking density. For the products analyzed, a Tg above 100° C. indicates a high crosslinking density.

TABLE 3

| | | Catalyst | | | |
|---|---|---|---|---|---|
| Example | | solution | Gel time | Tg | Optical |
| # | | # | [h] | [° C.] | assessment |
| 14 | comparative | 1 | >48 | 110 | Yellow, solid |
| 15 | comparative | 2 | >24 | 115 | Strong foaming |
| 16 | comparative | 3 | 5 | 91 | Yellow, solid |
| 17 | comparative | 4 | 23 | 95 | Brownish, solid |
| 18 | comparative | 5 | 24 | 94 | Orange, solid |
| 19 | comparative | 6 | 23 | 111 | Yellow, solid |
| 20 | comparative | 7 | 24 | 104 | Yellow, solid |
| 21 | comparative | 8 | >24 | 103 | Yellow, solid |
| 22 | inventive | 9 | >24 | 109 | Slightly yellow, |
| | | | | | solid |
| 23 | inventive | 10 | >24 | 106 | Yellow, solid |
| 24 | comparative | 11 | 6 | 97 | Yellow, solid |
| 25 | inventive | 12 | >24 | 105 | Yellow, solid |
| 26 | comparative | 13 | | | |

As can be seen from the results of application testing products obtained using catalyst solutions prepared with γ-diols have properties corresponding to the undiluted catalyst adduct. Thus, the use of appropriate dilutions of the thermo-latent catalyst with gamma-diols leads to a catalyst system which combines the outstanding chemical properties with a significantly improved handling.

1. A composition comprising
a) at least one adduct of a compound of formula (I) and a compound having at least one isocyanate group 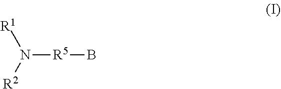
wherein R¹ and R² are independently of one another selected from the group consisting of hydrogen, methyl, ethyl, propyl, isopropyl, butyl and isobutyl, branched C5-alkyl, unbranched C5-alkyl, branched C6-alkyl, unbranched C6-alkyl, branched C7-alkyl and unbranched C7-alkyl;
R⁵ is selected from the group consisting of propylene, butylene, pentylene and a radical of formula (II); 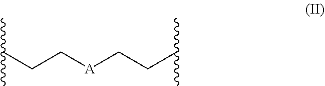
wherein A in formula (II) is selected from the group consisting of O, S and NR³, wherein R³ is selected from the group consisting of H, methyl, ethyl, propyl, isopropyl, butyl and isobutyl; and
B is independently of A selected from the group consisting of OH, SH NHR⁴ and NH₂, wherein R⁴ is selected from the group consisting of methyl, ethyl and propyl; and
b) at least one 7-diol with 3 to 12 carbon atoms.

2. The composition of claim 1, wherein the γ-diol comprises a 1,3-diol.

3. The composition according to claim 2, wherein the 1,3-diol is selected from the group consisting of 1,3-propanediol, 1,3-butanediol and 2-ethylhexane-1,3-diol.

4. The composition according to claim 1, comprising at least 90 wt.-% based on its weight of components a) and b).

5. The composition according to claim 1, wherein a weight ratio between components b) and a) is between 1:1 to 1:100.

6. The composition according to claim 1, wherein a weight ratio of components b) and a) is selected such that the viscosity of the composition does not exceed 100,000 mPa*s determined according to DIN EN ISO 3219 with a rotation viscosimeter.

7. A method for formation of isocyanurate groups comprising providing a composition as defined in claim 1 as a catalyst composition.

8. The method according to claim 7, wherein the isocyanurate groups are formed from isocyanate groups having aliphatically and/or cycloaliphatically bonded isocyanate groups.

9. The method according to claim 7, wherein a polyisocyanurate plastic is formed as matrix of a composite material.

10. A method for manufacturing a polyisocyanurate plastic, comprising the steps of
a) providing a composition as defined in claim 1;
b) mixing the composition provided in method step a) with a polyisocyanate composition at a temperature not exceeding 50° C. so that a reaction mixture having a molar ratio of isocyanate groups to isocyanate-reactive groups of at least 3: 1 is formed; and
c) curing the reaction mixture obtained in method step b) at a temperature between 60° C. and 300° C.

11. The method according to claim 10, wherein the polyisocyanate composition comprises at least 50 wt.-% of polyisocyanates having exclusively aliphatically and/or cycloaliphatically bonded isocyanate groups.

12. The method according to claim 10, wherein a fibrous filler having an aspect ratio greater than 1,000 is added to the reaction mixture obtained in method b) before initiation of method step c).

13. The method according to claim 10, wherein method step c) is initiated in a span of time of 2 to 24 hours after the end of method step b).

14. The method according to claim 13, wherein the reaction does not reach a gel point within said span of time.

15. A polyisocyanurate plastic obtained by the method according to claim 10.
